(19) United States
(12) Patent Application Publication
(10) Pub. No.: US 2009/0058596 A1
(43) Pub. Date: Mar. 5, 2009

(54) ACCESS CONTROL MEANS WITH BIOMETRIC SENSOR

(75) Inventors: Devi SOHANTA, Coventry (GB); Timothy James Gluyas, Leicester (GB); Jeremy Clive Ahern, Powys (GB)

Correspondence Address: YOUNG & THOMPSON, 209 Madison Street, Suite 500, ALEXANDRIA, VA, 22314, US

(73) Assignee: GLOBAL BIOTEC LIMITED, Coventry (GB)

(21) Appl. No.: 12/262,847

(22) Filed: Oct. 31, 2008

(30) Foreign Application Priority Data
Apr. 26, 2006 (GB) 0708189.6

(51) Int. Cl. G06F 7/04

(52) U.S. Cl. 340/5.53

(57) ABSTRACT

A biometric device fitted to, or adapted for fitting to, an access control member including a fastening element which is movable, in use, between a position in which it prevents opening of a closure and a position in which it permits opening of the closure, and operating members operable to move the fastening element between the positions through the agency of drive-transmitting elements operatively connected between the operating member and the fastening element, the device including elements incorporated in, or adapted to be incorporated in, the drive-transmitting elements and operable under the control of a biometric sensor to interrupt and restore the drive between the operating members and the fastening element.

This invention relates to access control means for controlling access to a space or enclosure.

In particular, the invention is concerned with access control means such, for example, as locks and latches of the kind comprising a fastening element movable between a position in which it prevents opening of a closure such, for example, as a door providing access to a building or part of a building, a door of a cupboard or cabinet or a lid providing access to the interior of a receptacle or container, and a position in which it permits opening of the closure, and operating means, for example a handle or knob, operable to move the fastening element between said positions through the agency of drive-transmitting means operatively connected between the operating means and the fastening element.

Moreover, the invention is specifically concerned with access control means of this kind in which opening of the closure is controlled by a biometric device. Such a device comprises a biometric sensor adapted to read unique human characteristics, for example fingerprints or eye irises, so as to identify authorised persons, the access control means being activated in response to the detection an authorised person by the sensor to permit opening of the closure.

Various forms of biometric access control means are known but they have a number of disadvantages.

The object of the present invention is to provide an improved form of access control means, especially a biometric access control means.

A particular aim of the invention is to provide a biometric control device that can be fitted to an existing access control means.

According to the invention there is provided a biometric device fitted to, or adapted for fitting to, an access control means comprising a fastening element which is movable, in use, between a position in which it prevents opening of a closure and a position in which it permits opening of the closure, and operating means operable to move the fastening element between said positions through the agency of drive-transmitting means operatively connected between the operating means and the fastening element, the device comprising means incorporated in, or adapted to be incorporated in, the drive-transmitting means and operable under the control of a biometric sensor to interrupt and restore the drive between the operating means and the fastening element.

The idea is that, in use, interruption of the said drive prevents movement of the fastening element by the operating means and opening of the closure, and movement of the fastening element to permit opening of the closure is permitted only when the drive is restored in response to the identification of an authorised person by the biometric sensor.

In the case of a lock or latch the drive-transmitting means is usually rotational, for example a spindle turnable by a handle or knob to operate the lock or latch. Such a construction may be adapted for the purposes of the invention by providing a two-part spindle having the means for interrupting and restoring the drive connected between the two parts. These means are preferably in the form of a clutch.

Preferably, the means for interrupting and restoring the drive between the operating means and the fastening element is operable by a motor under the control of the biometric sensor. This motor may be powered by electricity or fluid pressure. The motor may be a switch or a rotary electric motor but it is preferably a linearly operable solenoid adapted if necessary to convert the linear action of the solenoid into rotary movement

The clutch may comprise two elements which are movable by the motor into and out of driving engagement. Such engagement may be achieved mechanically or by friction.

The invention will now be described, by way of example, with reference to the accompanying drawings in which:—

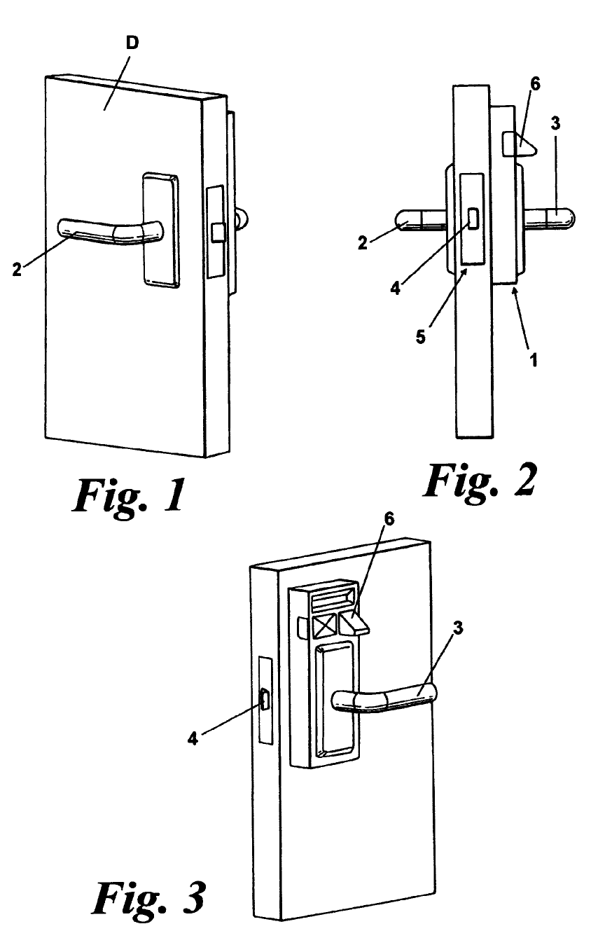

FIG. 1 is a schematic perspective view from one side of one form of biometric lock embodying the invention,

FIG. 2 is an end view of the lock shown in FIG. 1,

FIG. 3 is a perspective view from the other side of the lock shown in FIG. 1,

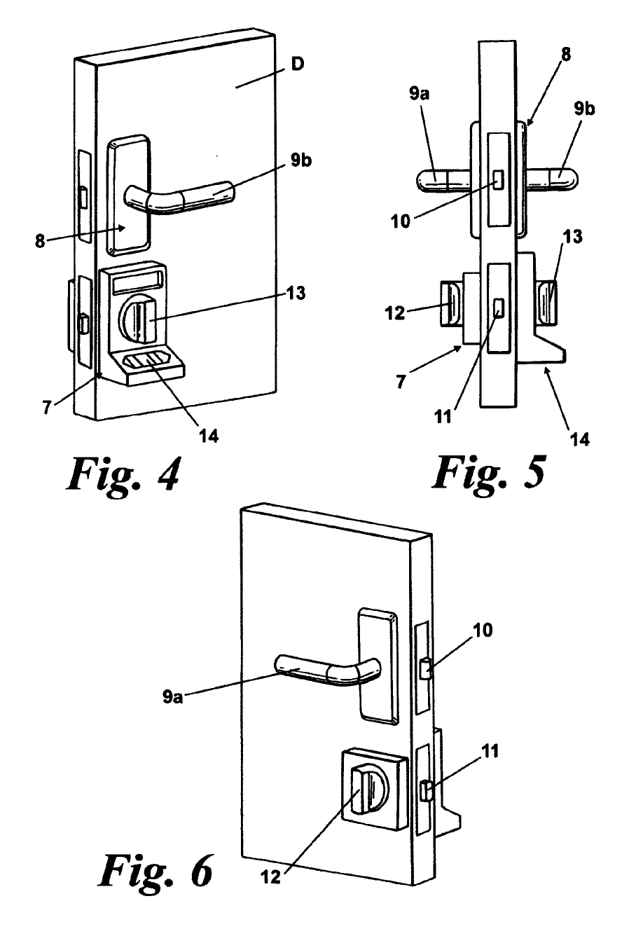

FIG. 4 is a schematic perspective view from one side of another form of biometric lock embodying the invention,

FIG. 5 is an end view of the lock shown in FIG. 4,

FIG. 6 is a perspective view from the other side of the lock shown in FIG. 4,

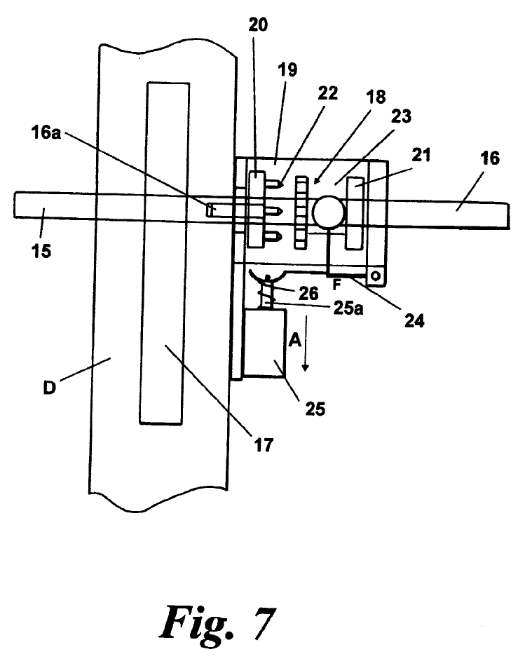

FIG. 7 is a sectional view of one form of operating means of a biometric lock according to the invention, and

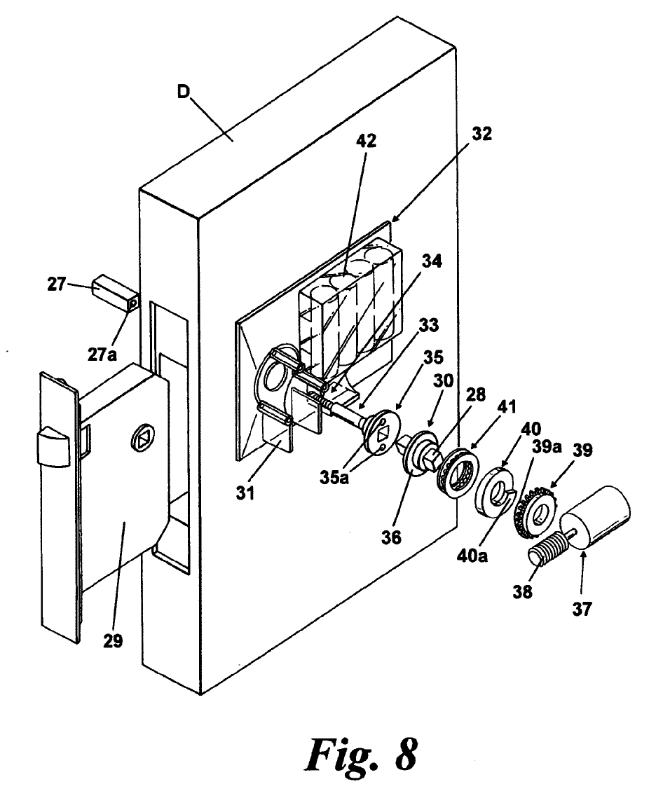

FIG. 8 is an exploded perspective view showing another form of operating means of a biometric lock incorporating the invention,

The biometric locks illustrated in the drawings are all designed for fitting to a door D. The door may be made of any suitable material such as timber, metal, metal-faced material, plastics, glass-reinforced plastics, carbon fibre or laminate.

FIGS. 1, 2 and 3 show the invention incorporated in a lock I having a latch mechanism operable from both sides of the door D by handles 2 and 3, the handle 3 being disposed at the outer side of the door from which access to the other side is required to be controlled. The latch mechanism has a latch element 4 which is spring-biased to an outer position in which it projects through an opening in a latch plate 5 and engages in an aperture in a strike plate (not shown) mounted in the frame of the door so as to prevent opening of the door. The latch element is movable to an inner position in which it is disengaged from the strike plate by turning one or the other of the handles 2 and 3 thereby to permit opening of the door.

Movement of the latch element is effected by turning a square section spindle which projects from opposite sides of the latch mechanism, the handles 2 and 3 being mounted on the respective ends of this spindle. In accordance with the invention the spindle is split at a location between the mechanism and the handle 3 into two parts and a clutch operable by a motor under the control of a biometric sensor 6 is interposed between the two parts of the spindle. The operation of this arrangement is described below.

FIGS. 4, 5 and 6 show the invention incorporated in a mortice deadlock 7 used in conjunction with a separate latch mechanism 8. This latch mechanism comprises handles 9a and 9b mounted on the ends of a square section spindle (not shown) which is turnable to move a latch element 10 between an outer position and an inner position in the same way as the arrangement described above in relation to FIGS. 1, 2 and 3.

The deadlock 7 has a bolt 11 similarly movable between inner and outer positions by a lock mechanism operable by knobs 12 and 13 mounted on the ends of a spindle (not shown) at the respective inner and outer sides of the door D, the door being secured against opening when the bolt is in the outer position and engaged with a keep (not shown) fixed to the door frame. When the bolt is in its inner position and disengaged from the keep the door can be opened by simply releasing the latch 8 and held closed by engaging the latch.

In accordance with the invention the spindle of the deadlock 7 is in two parts, namely a part carrying the knob 13 at the outer side of the door and a part which extends through the lock mechanism and carries the knob 12 at the inner side of the door. Connected between these two parts is a clutch operable by a motor under the control of a biometric sensor 14 at the outer side of the door.

FIGS. 7 and 8 show two forms of clutch arrangement which may be used in the locks illustrated in FIGS. 1 to 6.

In the clutch arrangement shown in FIG. 7 the two parts of the square section spindle for operating the lock are designated 15 and 16, the part 15 carrying the handle or knob at the inner side of the door and extending through the mechanism 17 of the lock to the outer side of the door where it is operatively connected by a clutch 18 to the part 16 of the spindle carrying the outer handle or knob. The clutch is located in a casing 19 which is mounted on the door D.

The end of the spindle part 15 remote from the inner handle or knob is formed with an axial blind bore which receives a spigot 16a formed on the opposed end of the spindle part 16.

The clutch 18 is a dog clutch comprising a stator 20 fixed to the spindle part 15 and a slider 21 mounted for axial sliding movement on the spindle part 16. The inner face of the stator is provided with four projecting pins 22 having radiussed tips arranged in a circle around the axis of the stator. The part of the stator remote from the pins is located in the casing 19. The slider 21 has an axial square bore through which the spindle part 16 extends so that the slider is a free sliding fit on the spindle part, and four blind bores arranged on movement of the slider towards the spindle part 15 to receive the pins 22 of the stator to engage the clutch and prevent turning of the two spindle parts relative to one another.

The slider 21 is formed with a circumferential groove 23 which is straddled by the two limbs of a fork formed at one end of a crank assembly 24 which is pivoted to the casing 19. Thus, pivoting of the assembly moves the slider along the spindle part 16 to engage and disengage the clutch. Such movement is performed by a solenoid 25 having a plunger 25a which is engaged by the crank assembly 24. A spring 26 is arranged to prevent accidental or unauthorised movement of the slider to the engaged position.

The solenoid 25 is a bistable latching solenoid operable by electrical pulses. When it receives a positive pulse its plunger moves downwards in the direction of the arrow A to cause the slider 21 to move to the engaged position. The plunger is then held in this position by an integral magnet so that the two spindle parts 15, 16 are locked together. The lock can therefore be operated by turning the inner or outer handle or knob to permit opening of the door D. After a pie-programmed time a negative pulse is sent to the solenoid causing the plunger to move upwards thereby disengaging the clutch so that if the outer handle is then turned it does not operate the lock and the door remains secured against opening from the outside. The door can then be opened only from the inside.

Operation of the solenoid 25 is controlled by an electronic system powered by batteries located in the casing 19 and including a biometric sensor such as those shown at 6 and 14 in FIGS. 1 to 6. This sensor may be adapted to read fingerprints, eye irises or any other appropriate human characteristics so as to identify authorised persons wishing to pass through the door.

The solenoid 25 requires only a short pulse to operate it, rather than a continuous electrical current, so that there is a reduced drain on the batteries.

The clutch is normally disengaged so that the door cannot be opened. When the sensor detects an authorised person the electronic system causes the clutch to be engaged and that person can then open the door. The system is provided with time-delay means which acts after a preset time from engagement of the clutch to cause the motor automatically to disengage the clutch.

The system can be programmed to allow a number of authorised persons to pass through the door and has facilities to enable authorisations to be removed and fresh ones added.

In the clutch arrangement shown in FIG. 8 the two parts of the square section spindle for operating the lock are designated 27 and 28, the part 27 carrying the handle or knob at the inner side of the door and extending through the mechanism 29 of the lock to the outer side of the door where it is connected by a clutch 30 to the part 28 of the spindle carrying the outer handle or knob. The clutch is located in a housing 31 attached to a mounting chassis 32 which is mounted on the door D.

The opposed ends of the two spindle parts 27, 28 are formed with two axially aligned bores (the bore in the part 27 being seen at 27a) which receive the end portions of a guide pin 33, a compression spring 34 being disposed between the bottom of the bore 27a in the part 27 and the opposed end of the guide pin 33. The spindle part 28 is mounted for axial movement in the housing 31 relative to the spindle part 27 which is held against axial movement, the spring 34 acting to urge the part 28 away from the part 27.

The clutch 30 comprises a first drive-transmitting ring 35 fixed to the spindle part 27 and a second drive-transmitting ring 36 fixed to the spindle part 28 so as to be movable towards and away from the ring 35. The ring 36 is provided with two diametrically opposed spigots which are arranged to enter two holes 35a in the ring 35 when the ring 36 is moved towards the ring 35 by axial movement of the spindle part 28 to engage the clutch. Such movement of the ring 36 is effected by an electric motor 37 having an output shaft carrying a worm gear 38 which meshes with a rotatable sprocket thrust ring 39. This thrust ring is in contact with a further thrust ring 40 which is axially movable along, but held against turning relative to the spindle part 28, their opposed faces being provided with cams 39a, 40a which act when the motor turns the ring 39 in one direction to move the ring towards the ring 36. As a result the ring 40 acts through the medium of a ball bearing 41 on the ring 36 to move it towards the ring 35 against the action of the spring 34 and thereby engage the clutch. When the clutch is engaged turning of the handle attached to the spindle part 27 causes the lock to be operated to permit opening of the door D. When the motor is operated to turn the sprocket thrust ring 39 in the opposite direction, the cams allow the ring 36 to move away from the ring 35 under the action of the spring 34 so that the spigots on the ring 36 are disengaged from the holes 35a in the ring 35. The clutch is thereby disengaged so that if the handle is then turned it does not operate the lock and: the door remains secured against opening from the outside.

Operation of the electric motor is controlled by an electronic system powered by batteries 42 located in the housing 31, the system including a biometric sensor such as those shown at 6 and 14 in FIGS. 1 to 6. This sensor may be adapted to read fingerprints, eye irises or any other appropriate human characteristics so as to identify authorised persons wishing to pass through the door.

The clutch is normally disengaged so that the door cannot be opened. When the sensor detects an authorised person the electronic system causes the clutch to be engaged and that person can then open the door. The system is provided with time-delay means which acts after a preset time from disengagement of the clutch to cause the motor automatically to disengage the clutch.

The system can be programmed to allow a number of authorised persons to pass through the door and has facilities to enable authorisations to be removed and fresh ones added.

The invention is applicable to many other types of locks including, for example, deadlocks, door bolts, slam latches, rim locks and espagnolette locks.

The invention is particularly suitable for locks for closures such as doors to which access is required from both sides of the closure in order to operate them to permit opening of the closure, a lock according to the invention allowing access to be controlled from one side only without affecting normal access from the other side.

A particular advantage of the invention is that a biometric device according to the invention can be fitted to an existing lock or latch, the spindle being replaced by the two-part spindle of the device with the associated clutch, solenoid or electric motor and electronic system including the biometric sensor.

1. A biometric device fitted to, or adapted for fitting to, an access control means comprising a fastening element which is movable, in use, between a position in which it prevents opening of a closure and a position in which it permits opening of the closure, and operating means operable to move the fastening element between said positions through the agency of drive-transmitting means operatively connected between the operating means and the fastening element, the device comprising means incorporated in, or adapted to be incorporated in, the drive-transmitting means and operable under the control of a biometric sensor to interrupt and restore the drive between the operating means and the fastening element.

2. A biometric device as claimed in claim 1 which is fitted to, or adapted for fitting to, an access control means in which the drive-transmitting means is a spindle turnable to transmit drive from the operating means to the fastening element, wherein the spindle is formed in two parts having the means for interrupting and restoring the drive operatively connected between said parts.

3. A biometric device as claimed in claim 1 wherein the means for interrupting and restoring the drive between the operating means and the fastening element is a clutch.

4. A biometric device as claimed in claim 3 wherein the means for interrupting and restoring the drive between the operating means and the fastening element is operable by a motor under the control of the biometric sensor.

5. A biometric device as claimed in claim 4 wherein the motor is an electric motor.

6. A biometric device as claimed in claim 4 wherein the motor is a solenoid.

7. A biometric device as claimed in claim 5 wherein the clutch comprises two elements which are movable by the motor into and out of driving engagement.

8. A biometric device as claimed in claim 6 wherein the solenoid is a bistable solenoid operable by electrical pulses.

9. A biometric device as claimed in claim 8 wherein the solenoid is operable to engage the clutch by a first pulse, a second pulse causing the solenoid to disengage the clutch after a preset time.

10. A biometric device as claimed in claim 8 wherein the solenoid is arranged to operate the clutch through a crank assembly.

11. A biometric device as claimed in claim 5 wherein the electric motor is arranged to operate the clutch through a worm gear.

12. A biometric device as claimed in claim 7 which is fitted to, or adapted for fitting to, an access control means in which the drive-transmitting means is a spindle turnable to transmit drive from the operating means to the fastening element, wherein the spindle is formed in two parts having the means for interrupting and restoring the drive operatively connected between said parts, and wherein the clutch comprises a stator fixed to one part of the spindle and a slider mounted on the other part of the spindle for movement towards and away from the stator.

13. A biometric device as claimed in claim 7 wherein one of the elements of the clutch is provided with pins which are engageable in and disengageable from bores in the other element.

14. A biometric device as claimed in claim 1 wherein the means for interrupting and restoring the drive between the operating means and the fastening element is operable by a motor under the control of the biometric sensor.
